(19) United States
(12) Patent Application Publication
(10) Pub. No.: US 2016/0086130 A1
(43) Pub. Date: Mar. 24, 2016

(54) METHOD AND APPARATUS FOR FOREIGN TRADE AND EXPORT CONTROL

(71) Applicant: Unify GmbH & Co. KG, Munich (DE)

(72) Inventors: Helmut Monz-Schneider, Pfaffenhofen (DE); Christoph Eder, Munchen (DE)

(21) Appl. No.: 14/956,561

(22) Filed: Dec. 2, 2015

Related U.S. Application Data
(63) Continuation of application No. 12/893,061, filed on Sep. 29, 2010.

(51) Int. Cl. G06Q 10/08; G06Q 30/06

(52) U.S. Cl. CPC G06Q 10/0831; G06Q 30/0607; G06Q 30/0635

(57) ABSTRACT

A method and apparatus for export control includes providing input for an invoice to a computer device. The invoice is for a sale or potential sale of at least one of goods and services. A computer device determines whether at least one of a customer, location for receipt of goods, and location for receipt of services is associated with an embargo state. The computer device blocks any portion of the invoice determined to be associated with an embargo state. The computer device determines if the at least one of goods and services requires at least one export license or other permission for exporting the at least one of goods and services. The computer device assigns permissions that are available. The computer device also communicates or identifies any permission or export license that is needed to be requested to initiate a permission or export license request for that export license or permission.

### FIELD OF THE INVENTION

The present invention relates to methods, devices and systems utilized for ensuring parties are compliant with foreign trade and export control regulations. Such systems and methods may be utilized in applications that are stored in memory and run by one or more processors or microcontrollers of electronic devices such as desktop computers, workstations, or other computer devices or a networked computer device that has access to databases and other data structures stored or maintained on other devices via at least one network connection and/or at least one direct connection.

### BACKGROUND OF THE INVENTION

In order to fulfill global trade compliance and regulations for any shipments of goods and services, businesses often must identify what goods or services are being provided to a particular end customer and customer location. If the customer location is in certain countries, it may be necessary to obtain an appropriate export license for those goods or services. Such businesses are also required to verify that applicable laws and regulations do not prohibit sending the goods or services to that end customer or customer location. To verify that an appropriate export license is needed, apply for that particular license and receive that license prior to shipping a particular order can be a very time consuming enterprise. But, certain sales may require very quick action.

Some vendors provide software solutions to help businesses control their foreign trade and exporting activities and comply with their obligations for obtaining the proper licenses for foreign sales. For example, SAP provides Legal Control software to provide such assistance. The SAP Legal Control software requires substantial customization and maintenance for the software to work. For instance, customer specific information must be provided to the Legal Control software and a product master data module or database may also be necessary for the Legal Control software to properly function. Such data must also be maintained to ensure the data stays accurate and reliably usable. Customization and maintenance may also be necessary for the software to be able to determine if a particular customer is acquiring a product or service for military or civilian use.

Customization and maintenance of such a software application for a particular end user substantially increase the cost of that software. Further, such customization may substantially reduce the ability of the software to adapt to changes that a business may undergo, such as acquiring or divesting certain subsidiaries or subdivisions of a business.

A new method or apparatus for providing foreign trade and export control is needed. Such a method or apparatus is preferably operable on a desktop computer or other computer device to provide an automated or highly automated process for providing foreign trade and export control information and documentation. Such a method or apparatus also preferably requires minimal, if any, customization for a particular end user to effectively use.

### SUMMARY OF THE INVENTION

A method and apparatus for export control are provided. Embodiments of the apparatus may permit embodiments of the method to be practiced. Preferably, embodiments of the apparatus and method are usable for both civil and military products and service. Embodiments of the apparatus also preferably permit export control to be automatically executed with a minimal amount of user input. Embodiments of the apparatus may also be configured so that little or no customization is needed for different end users or businesses that may utilize such embodiments. The reduction or elimination of customization can permit the cost of such apparatuses to be greatly reduced. Further, the automatic nature of the export control may help greatly reduce the costs and time required in providing export control services to a business.

For instance, a computer device may be configured to receive input for an invoice or order. The invoice may relate to a delivery of at least one of goods and services. The input may include user input and other input obtained from databases or other modules or servers connected to the computer device. The computer device may determine whether at least one of a customer, location for receipt of goods, and location for receipt of services is associated with an embargo state. The computer device blocks any portion of the invoice determined to be associated with an embargo state. The computer device determines if the goods and/or services require at least one export license or other permission for exporting the goods and/or services. The computer device assigns permissions that are available and communicates or identifies any permission or export license that is needed to be requested to initiate a permission or export license request for that export license or permission.

In some embodiments, the computer device may be a system or a computer apparatus. For instance, a system similar to the systems shown in FIG. 4 or 5 may be an example of the computer device.

Preferably, embodiments of the method permit the computer device to automatically make most, if not all of the determinations discussed or referenced above. The computer device may include a processor, and a non-transitory memory unit. A display device and input devices may be connected to the computer device. The computer device may also be a system that includes other devices connected to the computer device, such as servers or databases. Such devices may be connected to the computer device via a network connection, such as an intranet connection or an internet connection.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of the method and apparatus for foreign trade and export control are shown in the accompanying drawings.

FIG. 1 is a perspective view of a present preferred computer device that may be configured to utilize a present preferred method for foreign trade and export control.

FIG. 2 is a flow chart illustrating a first present preferred method for providing foreign trade and export control. An optional printing step of the embodiment of the method shown in FIG. 2 is illustrated in dotted line.

FIG. 3 is a flow chart illustrating a second present preferred method for providing foreign trade and export control.

FIG. 4 is a block diagram illustrating a present preferred system that may be utilized for providing foreign trade and export control. An advance warning device (AWD) is illustrated in dotted line in FIG. 4. The AWD may be a portion of the Product/ECCN determination device or be a separate component that is directly attached to the Product/ECCN determination device or be connected to the computer device via a direct connection or a network connection. It should be appreciated that an ECCN may be an export control classification number, which is a type of export control code assigned by a particular country.

FIG. 5 is a block diagram illustrating another present preferred system that may be utilized for providing foreign trade and export control.

### DETAILED DESCRIPTION OF PRESENT PREFERRED EMBODIMENTS

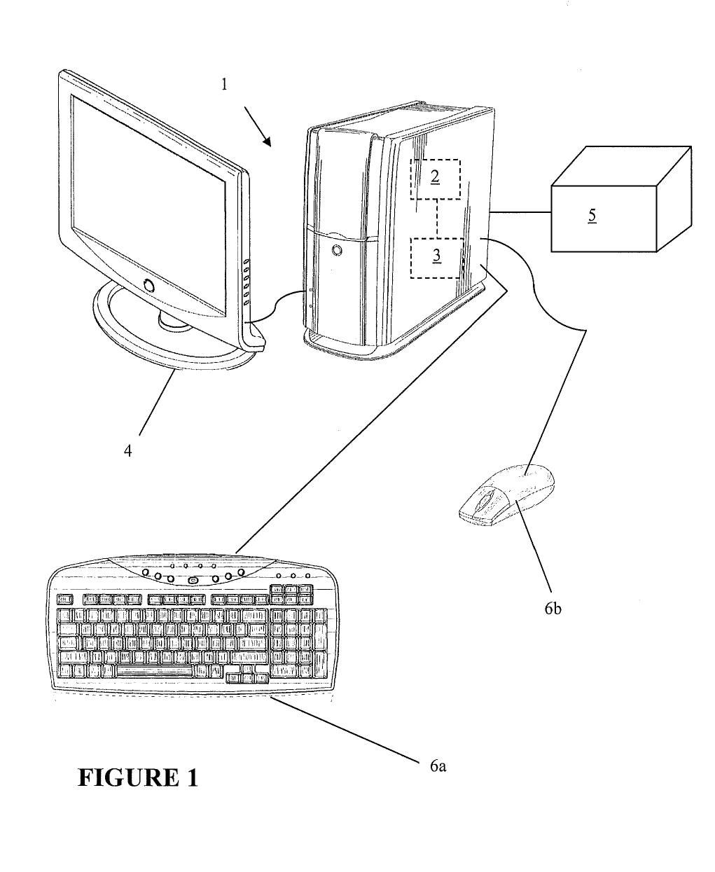

Referring to FIG. 1, a computer device 1 may include a processor 2, memory 3 connected or interconnected to that processor, a display device 4, a printer 5, and one or more input devices. The input devices may be a keyboard 6a, a mouse 6b, a barcode scanner, a RFID tag scanner, a combination of such devices or other input devices. The display device 4 may be a monitor, liquid crystal display or other type of display unit. The processor 2 may be only one processor or microprocessor or may include a plurality of interconnected processors. Similarly, the memory 3 may be only one memory unit or may be a plurality of memory units connected to the processor 2. The memory 3 could also be a plurality of interconnected memory units. Preferably, the memory 3 is non-transitory memory.

The computer device 1 may be connected to a database or other service maintained by another computer device such as a dedicated computer or a dedicated server via a network connection. Alternatively, the computer device may have one or more databases stored in the memory 3 of the computer device to eliminate the use of such computer devices or to reduce the use of such dedicated computer devices.

The memory 3 may have a software application stored therein. The software application may be run by the processor 2. The software application may include code that defines a method that the processor may implement or run. For example, a computer device that has the software application may be configured to process a method defined by the code of the software application. The software application may be designed so that a user of the computer device 1 may determine whether an export license should be obtained for a potential sale of product or services or if that potential sale should not occur because it violates the law of a country in which the user is located or in which the user's employer, such as a business, is located.

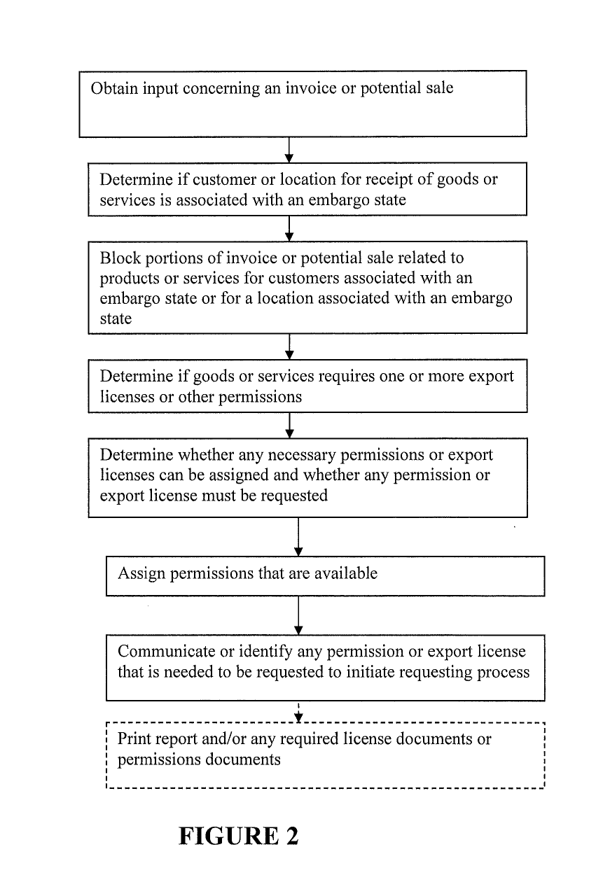

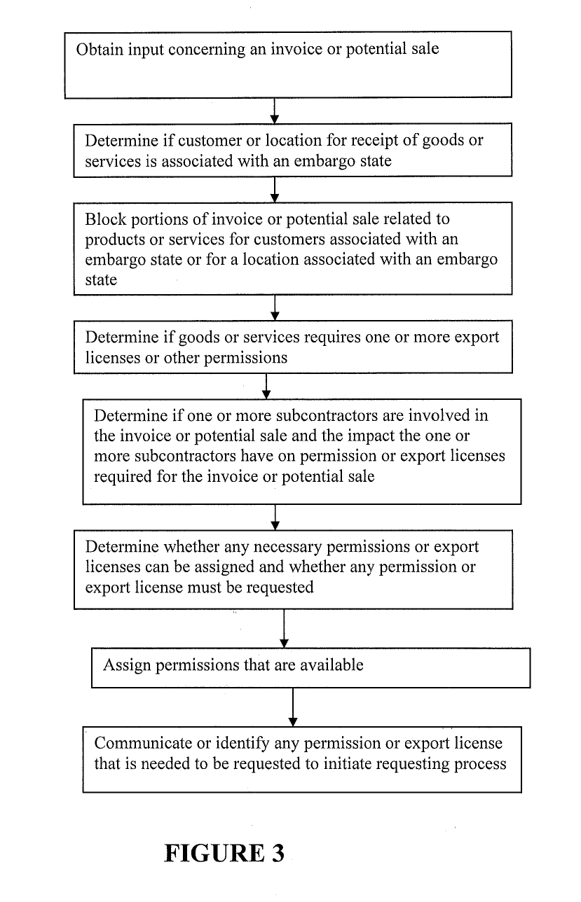

One embodiment of a method that includes a number of steps for foreign trade and export control that may be defined via a software application is shown in FIG. 2. Another example of such a method is shown in the flow chart of FIG. 3. As may be appreciated from FIGS. 2-3, an embodiment of the method may include entering input concerning a potential new sale or an actual sale or order. Such data may include information such as an order or a potential new invoice that may be entered via an input device so that the end user or end customer of the products or services listed in the entered invoice are identified to the software application. Such invoice data could also be provided by entering an invoice number that identifies the invoice in a particular database accessible to the computer device 1. The software application may be configured so that such input causes the computer device to access the database that includes the invoice data to obtain more specific information about that invoice, such as the end customer for the invoice and the goods or services being sold or potentially sold for that invoice.

The software application may be configured to determine if any end user, end customer, partner of that end user, or location in which the products or services are being shipped is an embargo state or associated with an embargo state. Such information may be obtained for both civil and military cases. The same customer may act as a civil customer for one order and a military customer in a different order. In some embodiments, the software may be configured so that the computer device running the software is able to obtain additional information, such as advanced warning verification information. For instance, the software may have a function that calls a number of red flag questions that are displayed or otherwise communicated to a user to determine whether the order or proposed order involves an embargo country. A user may then provide input to the computer device running the software in response to these questions or queries. The received input is evaluated to determine whether an embargo country is improperly involved in a sale or proposed sale. If improper involvement of an embargo country is detected based on the input data received from the user, the order or proposed order is blocked.

If an embargo country is determined to be involved in a sale or proposed sale, the entire order may be blocked and the computer device 1 may display data via display device 4 informing a user that the potential sale is improper and should not be made. It the order contains goods subject to an embargo and goods that are permitted to be sold, the computer device will identify each type of goods and may change the order and invoice to be limited to only those items which are permitted to be sold. In other embodiments, the computer device may be configured to block any invoice for goods or services to be sent to an embargo country or an entity associated with an embargo country.

The blocking of an invoice, order or potential order may occur in any of a number of other ways. For instance, an invoice or proposed order may be blocked by the computer device 1 preventing permissions to be granted to the invoice or proposed sale. Blocking may also occur by a deletion of the blocked goods or services from an invoice or the elimination, deletion or voiding of an invoice or proposed sale. As yet another example, blocking may be effected by communicating the fact that the invoice or proposed invoice should be blocked via a display device or printer connected to the computer device 1. An invoice may also be blocked by printing off or displaying a list of permissions needed for the invoice that does not currently exist and an identification off what is needed to obtain the necessary permissions. A blocked order may also be communicated by displaying a traffic light icon that shows a red light or other indicia indicating that an order is blocked or should be blocked. Detailed information about the blocking may also be provided to the user via a printer or display device. Such information may be provided after the computer device 1 runs a root cause analysis on the data concerning an order or proposed order and why that order was blocked to produce such detailed information.

In embodiments where the computer device 1 may be coupled to databases or services to obtain invoice data or other data for the export control software application run by the computer device 1, the computer device 1 may be configured to void certain portions of the invoice data or otherwise communicate void data to the databases or services to which the computer device 1 is connected to update the database or service to block any potential order or contemplated order. For instance, the computer device 1 may transmit data to a database to identify an invoice that is to be voided so that the database updates that invoice data to show the invoice is voided. The transmitted void data may also include indicator data that identifies the reason why the invoice was voided such as, for example, the fact that a customer, shipping location, or partner for the invoice was associated with an embargo state.

A voided portion of an order may also be communicated by displaying a traffic light icon that shows a yellow light or other indicia indicating that a portion of an order is blocked. Detailed information about the voided portion of the order may also be provided to the user via a printer or display device. Such information may be provided after the computer device 1 runs a root cause analysis on the data concerning the voided portion of the order or proposed order and why that order was voided to produce such detailed information.

If no embargo state is identified, then the computer device 1 may be configured to prompt a user for input to determine further information associated with the potential sale of product. Such input may include data concerning an invoice. Alternatively, the computer device 1 may be configured to automatically verify that the invoice data it previously reviewed is accurate by checking that data with data maintained in memory of the computer device or maintained by a database or other device connected to the computer device 1, such as a server or other computer device. The computer device 1 may also be configured to periodically or constantly verify any changes in an order or proposed order to ensure that the ordered product or service has a valid export classification control number (ECCN). It should be appreciated that the ECCN number may be an export control classification number or other type of code, which is an export control code assigned by a particular country. In the U.S., for example, such a code is referred to by the ECCN acronym. As another example, in Germany, such a code may be referred to as an Ausfuhrlistennummer or AL. It is contemplated that some export control codes may only use numbers, letters, or combinations of numbers in letters. Other export control codes may utilize various other types of symbols or indicia alone or in combination with letters and numbers.

After the input is verified and a correct invoice entry is determined to have been accessed by the computer device 1, the computer device may determine what goods or services are to be shipped, where the final receiver country is and what the country of dispatch for the goods or services is. Typically, the receiver country is always part of an order or invoice. The computer device 1 may be configured to verify that the receiver countries match a known country list according to the international ISO alpha code or other list or table utilized by the computer device to verify receiver countries.

If the country of dispatch and the location of the final receiver are within the same country, then there is no export involved and no export license is needed. For example, if the buyer is located in the U.S.A. and the U.S.A. is the country of dispatch, and the final receiver is also located in the U.S.A., then no export license is needed and the computer device 1 is configured to determine that no export license is needed and provide data via display device 4 indicating that no export license is needed. The computer device 1 may also provide data to other computer devices or databases to which it is connected to update export license status for that data to indicate that no export license is needed for the reviewed invoice.

If the final receiver is in a country other than the country of dispatch, then an export license may be needed and the computer device is configured to further evaluate the invoice. The export control classification number for each product, good or service involved in a potential sale or identified in the invoice may then be obtained. Such data may be obtained via a database maintained on a server to which the computer device is connected or may already be included in the invoice data previously obtained and reviewed by the computer device 1. As another alternative, the ECCN data may also be available for the different products involved in the proposed invoice or potential sale via a database or other data structure that may be stored on the memory 3 of the computer device and may be obtained from a search of that local memory. For example, a database may reside on memory or be otherwise accessible by the computer device 1 that includes a list of products and services offered by a company that has the ECCN data associated with those goods and services related or linked to the goods or services information. The list of products or services may include full identifications of the products or services or codes or other indicia that otherwise identify those products and services. The data structure is configured such that the computer device 1 may access the data structure to determine the ECCN data for the goods or services of a particular invoice merely by knowing what the products or services are or knowing a code corresponding to those products or services. The code may identify a general class of goods in which the particular products or services that are identified in the invoice fall within, thereby avoiding the need for customization of any database that maintains the ECCN data for particular goods and services. The code may be a number code, alphanumeric code, or other type of code.

The data structure for the ECCN data may be, for example, a part of a product master data information set that is accessible by the computer device. ECCN data may also be available to the computer device 1 via user input. Such user input may be obtained by queries communicated to a user via a display device. For instance, text or audio queries may be communicated to a user via a display device to obtain user input for the ECCN data. Such user input may be provided to the computer device 1 via an input device such as a keyboard or mouse.

Once the ECCN data is obtained for the products at issue in the proposed sale or invoice, regulations covering the ECCN for each product are reviewed to determine if the export of that product prevents reexporting that product. The computer device 1 may make such a review by being configured to review regulations that may be applicable to the product to verify that any reexporting of the product is acceptable under the applicable laws. If reexporting of the product is prevented, then the computer device is configured to determine if the products being sold were obtained via an import/export arrangement or not. For instance, if the products to be sold or shipped were not initially imported to the company, then the proposed sale or invoice is not blocked. If the products being exported were initially obtained as an export, then the sale or proposed invoice is blocked.

If the products or services of the proposed invoice or sale are not being reexported, the computer device is configured to subsequently determine the final receiver and each intermediate receiver of the products or services to be exported and the countries in which those receivers are located. After all the receiver countries are identified, permission assigning for each receiver country is effectuated by the computer device. Such permission assigning may be effected by the computer device transmitting data concerning the proposed sale or invoice to another computer device to have permissions assigned to that sale or invoice for each identified country.

For instance, a permissions computer device may be configured to assign permissions to the different products. The permissions may include assigning one or more licenses that the company has been granted to the sale or proposed sale. After the permissions have been assigned to the proposed sale or invoice, the granted permissions are evaluated to determine if the assigned permission provides sufficient authorization for the proposed sale or invoice. If insufficient permissions are provided, then the proposed sale or invoice is blocked.

In some embodiments, each individual portion of an order or proposed order may be assigned a license or be blocked for a failure to have the necessary permissions. The permissions device may assign such licenses or identify the failure of such necessary licenses to be assigned and communicate that information to the computer device 13 so that the computer device 13 may communicate the status of the order to a user.

If a permission is not available for a final receiver country for a product to be sold or an intermediate receiver country, then the computer device may be configured to block the proposed invoice or sale. In contrast, if a product is determined to be a product that does not require any assigned permissions or export licenses, such as an EAR99 product, permission is determined to have been effectively and adequately assigned and the order may be filled.

After a determination is made as to whether an export license or other permission is required, the system may print a report. The system may also be configured to assemble and print an invoice, export control license request, or other export control license related documents and documents associated with shipping the products or services identified in an order or invoice.

In some arrangements, a business partner or contract partner for a sale or proposed sale may be involved. In such cases, the licenses assigned to the contract partner or business partner may be available for assigning for use in a sale or proposed sale of products or services. The export licenses or permissions of a contract partner may be stored or be otherwise available to the computer device 1. If an order or proposed order includes any contract partner, the contract partner assessment device may be configured to also evaluate the available export permissions and licenses of the contract partner for assigning to an order.

The embargo countries for the contract partner may also be identified and it may also be verified that no embargo country for the contract partner is involved in an order or proposed order. If an embargo country for the contract partner is identified, the order may be blocked as discussed above.

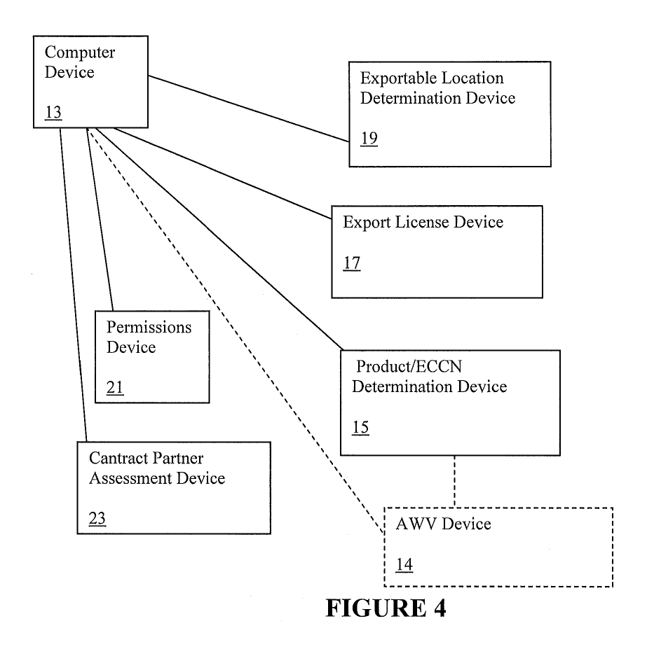

Referring to FIG. 4, an apparatus such as a system 11 is shown that is configured to practice embodiments of the above discussed methods. The system 11 includes a computer device 13 that is connected to a Product/ECCN determination device 15, an export license device 17, an exportable location determination device 19; a permissions device 21, and a contract partner assessment device 23. Each device 15, 17, 19, 21 and 23 may be databases or may be different computers networked to the computer device 13. Each device 15, 17, 19, 21 and 23 may also be connected to other devices via a network connection or other connection. Alternatively, each device may be a module of the computer device 13 or may be applications or data structures stored on memory of the computer device 13. It should be appreciated that such configurations may depend on the particular design objectives and costs objective of the system 11.

It should be appreciated that modularity of a design for the computer device may have some advantages. For instance, modularity of the design for the computer device may make updating the computer device 13 easier by requiring updates to only impact one module instead of the whole device.

The computer device 13 may be configured to automatically determine the necessary export licenses needed to fulfill an invoice or proposed invoice after receiving input from a user that identifies the invoice or proposed invoice, such as an invoice code, or indicia that identifies the invoice or a proposed invoice. Alternatively, the computer device 13 can be configured to automatically determine the necessary export licenses needed to fulfill an invoice or proposed invoice after receiving input from a user that identifies the particulars of an invoice or proposed invoice, such as the products or services to be sold, the customer, the locations in which the sold process or services may be stationed in the process of being shipped and other information that may be obtained by transmitting questions or queries to a user or user device.

The particular data specific to a particular invoice may be stored in memory or in a database connected to the computer device 13. The computer device 13 may be configured to access that data upon receiving invoice data input, such as an invoice code. Upon receipt of the invoice data input, the computer device may be configured to automatically determine if the proposed invoice or invoice is for a customer that is on a no-export list such that the invoice should be blocked and also determine if other export regulations may apply that require the shipment to be blocked. The computer device 13 may also be configured to automatically determine whether an export license is required for the shipment and if such an export license is currently possessed by the user or user's business for assigning to the invoice to permit that shipment to occur.

For example, the computer device may be configured to determine if an invoice contains product that should not be shipped by communicating with an export location device so that the computer device is able to determine if a location or entity associated with a location is determined to be on a no-export list or is otherwise not permitted to receive an export of a particular type of product or service of the invoice, that portion of the invoice or the invoice may be blocked.

If the computer device 13 determines that the invoice does not involve a location that is on a no-export listing, then the computer device may subsequently communicate with the Product/ECCN determination device 15 to determine what products or services of the invoice relate to a particular export control code or number. Thereafter, the computer device may utilize the export control code data obtained from the Product/ECCN determination device to determine whether any export licenses are needed for the products or services of the invoice via the export license device 17. Based on the data obtained from the export license device 17, the computer device 13 may determine whether the business has the sufficient export licenses already granted to it that are needed to fill the order via the permissions device 21. If the permissions device 21 provides the computer device 13 with a communication or data indicating that the necessary export licenses are not currently owned or assigned to the business, then the computer device 13 is configured to inform the user that export licenses are needed and display data related to the necessary and needed export licenses so those licenses can be requested or obtained.

The computer device 13 may also be configured to determine if an invoice requires the use of one or more contract parties, such as subcontractors. If one or more subcontractors or other contract parties are involved in the delivery of products or services that are exported, the computer device 13 may be configured to communicate with the contract partner assessment device 23 to determine if any additional permissions are needed for the exporting of the goods or services. To the extent the use of a contract partner, such as a general contractor partner or subcontractor partner, may permit the use of a license owned by that partner, the contract partner assessment device 23 may also be configured to permit the assigning of such licenses to an order. The contract partner device may also be configured to determine if the permission that was previously identified must be changed to a different permission or whether no change to the permissions or new permissions are required due to the involvement of the one or more contract parties or contract partners. A database, table or data structure of contract parties and the permission requirements associated with the involvement of those contract parties may be utilized by the contract partner assessment device 23. That database, table, or data structure may be updated or otherwise changed to reflect changes in the law that affect the permissions required for use of such contract parties or changes to contract partner ownership or capabilities that may occur over time.

In some embodiments of the system shown in FIG. 4, all the components of the system may be connected together within the same housing. Other embodiments of the system may utilize different components that are connected together via network connections or direct connections, such as direct wiring connections or other direct connection mechanisms.

In some embodiments of the apparatus, the system 11 may be configured so that the permissions device 21 and export license device 17 are portions of one device, such as a work station or server. In other embodiments, the export license device 17 and the exportable locations determination device 19 are portions of a server or workstation that is configured to provide the result of whether an export control license is applicable or not to an order or proposed order. In yet other alternative embodiments of the apparatus, the Product/ECCN determination device 15, an export license device 17, an exportable location determination device 19, a permissions device 21, and contract partner assessment device 23 may all be portions of a server connectable to the computer device 13 or may be modules of the computer device 13.

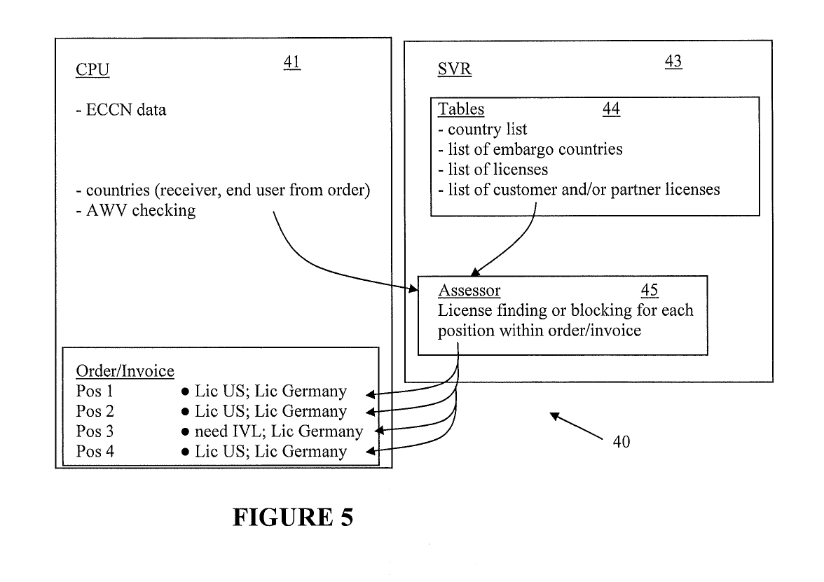

Referring to FIG. 5, an alternative embodiment of an apparatus is illustrated as a system 40 that includes a computer device (CPU) 41 that is connected to a server (SVR) 43 that includes a number of tables 44 and an assessor 45, which may be an assessor device or assessor mechanism. The computer device 41 may be configured to determine the ECCN data, advanced warning notification functionality and identifying receiver countries and end users from an order or proposed order evaluated by the computer device 41. For instance, the computer device 41 may have memory that includes data about an order or invoice that includes the ECCN data for different products or services for the invoice, the countries involved in the invoice, such as the receiver countries and end user entity for the invoice, and advanced warning information obtained via an advanced warning verification mechanism. Such advanced warning data may be data obtained by input received from a user in response to red flag queries or other queries asked about a particular order via a display device or other output device. The red flag queries may include questions to verify that the order information is accurate, and that the end user, customer and receiver country is properly identified, whether the order is military related, and whether any potential blocking is identified as a result of input obtained from the red flag queries. If potential blocking is found, such data may be communicated to the user via an output device connected to the computer device CPU 41.

The computer device may also be configured to have export determinations and license statuses for the order assessed via an assessor 45 or assessor mechanism. Such an assessor 45 may be part of a server 43 connected to the computer device via a network connection. For embargo checking, the assessor may obtain the advanced warning input from the computer device 41 and the country related data about the order from the computer device and compare that data to tables containing embargo countries or a list of embargo countries applicable for that order. If an order involves an embargo country, the assessor may block the order or the portion of the order affected by the improper involvement of an embargo country. The block status and information about that blocking may then be communicated to the computer device 41 for outputting via an output device to a user.

The assessor 45 may also identify licenses available for a particular order or determine whether an order or portion of an order is to be blocked due to the lack of available licenses. The assessor 45 may also assign permissions to the order, such as export licenses or other permissions. The assessor 45 may check the available licenses by checking tables that contain lists of licenses available to the exporter or a contract partner or business partner (debtor licenses) for the order. If licenses are available for all the services or products, the permissions may be assigned and the order may not be blocked.

If an unavailable license is found to be needed, a portion of an order may be blocked or the entire order may be blocked. For instance, if an individually validated licenses IVL is found to be needed for one product or service, that portion of the order may be blocked. If licenses Lic are needed for services or products in an order/invoice Pos1, Pos2, Pos3 and Pos4 that are available for assigning, the assessor 45 may assign the licenses Lic to those portions of the order. For instance, German license and U.S. licenses (Lic Germany and Lic US) necessary for exporting products or services in the order may be assigned by the assessor45.

It should be appreciated that embodiments of the method and system discussed above may be utilized for both civil and military related sales or potential exports. Further, embodiments of the systems and methods may be utilized so that no customization is needed for a particular customer's products or services. Moreover, maintenance for embodiments our apparatuses may be simplified and less expensive than conventional systems. For instance, because the computer device 13 may be configured to utilize different modules for practicing embodiments of the method, the maintenance of such systems are easier as the maintenance can be done on a module to module basis and may not require maintenance or updating of all the components of the computer device 13 needed for practicing the methods discussed above.

In the foregoing description, we have described the review of invoices or orders. It should be understood that embodiments of the method and apparatus could also be used to review purchase orders, quotations, proposals, or other documents or communications involving the sale or proposed sale of products or services. Therefore, invoice as used herein should be understood as encompassing all such documents, communications, proposed sale transactions and sale transactions.

While certain present preferred embodiments of the method and apparatus for foreign trade and export control have been shown and described above, it is to be distinctly understood that the invention is not limited thereto but may be otherwise variously embodied and practiced within the scope of the following claims.

1-20. (canceled)

21. A method of providing export control comprising:
providing input for an order to a computer device having non-transitory memory and a processor connected to the memory, the order comprising a sale or potential sale of at least one of goods and services;
the computer device identifying all receiver countries associated with the order to account for an entire supply chain associated with the order, the receiver countries comprising intermediate receiving countries and final destination countries for the order;
the computer device determining whether at least one of a customer, location for receipt of goods, and location for receipt of services is associated with an embargo state based on the identified receiver countries;
the computer device blocking a first portion of the order determined to be associated with an embargo state by removing that first portion of the order associated with the embargo state;
the computer device determining whether the at least one of goods and services requires at least one export license or other permission for exporting the at least one of goods and services;
the computer device automatically assigning permissions or export licenses that are available;
the computer device communicating or identifying any permission or export license that is needed to be requested to initiate a permission or export license request for that export license or permission; and
the computer device blocking a second portion of the order upon a determination that all necessary permissions and necessary export licenses are not assigned to the second portion of the order;
wherein the blocking of the second portion of the order upon the determination that all necessary permissions and necessary export licenses are not assigned to the second portion of the order comprises deleting or voiding the second portion of the order that does not have all necessary permissions and necessary export licenses and communicating information identifying all necessary permissions and necessary export licenses needed for the blocked second portion of the order based on results from a root cause analysis of the order for communicating the information to a user via at least one of a display device and a printer.

22. The method of claim 21 further comprising:
the computer device determining whether at least one contract partner is associated with any of the at least one of goods and services and wherein the computer device is a computer system.

23. The method of claim 22 further comprising:
for each contract partner determined to be associated with any of the at least one goods and services, determining whether any additional permission is available for that contract partner and determining whether any additional export license is available for that contract partner.

24. The method of claim 23 wherein the second portion of the order missing the assignment of all necessary permissions and necessary export licenses is only a subpart of the order and is not the whole order; and
the computer device is comprised of at least one of a permissions device, an advanced warning verification device, a contract partner assessment device, an exportable location determination device, an export license device, and a product identifier determination device configured to determine export control numbers for the at least one of goods and services.

25. The method of claim 21 wherein the blocking of the second portion of the order upon the determination that all necessary permissions and necessary export licenses are not assigned to the second portion of the order also comprises communicating that the second portion of the order should be blocked to a user of the computer device.

26. The method of claim 21 further comprising:
after the computer device assigns the permissions or export licenses that are available, the computer device evaluating the order by running a root cause analysis of the order to determine any permission or export license that is needed for that order; and
wherein the at least one of goods and services is comprised of at least one of military goods, military services, civil goods and civil services.

27. The method of claim 21 wherein the second portion of the order missing the assignment of all necessary permissions and necessary export licenses is only a subpart of the order and is not the whole order; and
the blocking voids the second portion of the order to prevent delivery of the second portion of the order and the method further comprises:
removing items from the order associated with the blocked second portion of the order to which no necessary permissions and export licenses are available so that the order has all necessary permissions and necessary export licenses.

28. A computer system comprising:
a computer device connected to a product identifier determination device, an export license device, an exportable location determination device, a permissions device, and a contract partner assessment device, the computer device having non-transitory memory and a processor connected to the memory;
the product identifier determination device configured to determine export product identifiers for at least one of products and services identified in an order;
the export license device configured to identify export licenses required for exporting at least one of products and services identified in the order;
the exportable location determination device configured to determine a location of each and every receiver that receives at least one of products and services identified in the order for exporting of the at least one of products and services identified in the order, the receiver comprising at least one intermediate receiver and at least one final destination receiver;
the permissions device configured to automatically assign at least one of permissions and export licenses to at least a portion of the order;
the contract partner assessment device configured to determine whether any contract partner is identified in the order and determine any permissions that are required for exporting the at least one of products and services identified in the order;
the computer device configured to permit the order when all necessary permissions and necessary export licenses are assigned to the order; and
the computer device configured to block a first portion of the order when all necessary permissions and necessary export licenses are not assigned to the first portion of the order such that the first portion of the order that does not have all necessary permissions and necessary export licenses is deleted or voided and the computer device configured to communicate information via at least one of a printer and a display device connected to the computer device, the communicated information identifying all necessary permissions and necessary export licenses needed for the blocked first portion of the order based on results of a root cause analysis of the order performed by the computer device.

29. The system of claim 28 wherein the product identifier determination device is connected to the permissions device, the export license device is connected to the permissions device, the exportable location determination device is connected to the permissions device, and the subcontractor assessment device is connected to the permissions device.

30. The system of claim 28 wherein the computer device is connected to the product identifier determination device via a network connection, the computer device is connected to the export license device via a network connection, the computer device is connected to the exportable location determination device via a network connection, the permissions device is connected to the computer device via a network connection, and the computer device is connected to the subcontractor assessment device via a network connection.

31. The system of claim 28 wherein the first portion of the order is a subpart of the order and is not the whole order; and
the product identifier determination device, the export license device, the exportable location determination device, the permissions device, and the subcontractor assessment device are interconnected modules.

32. A communication system comprising:
a computer device connected to a product identifier determination device, an export license device, an exportable location determination device, a permissions device, and a contract partner assessment device, the computer device having non-transitory memory and a processor connected to the memory;
the computer device connected to at least one input device to receive user input, the user input comprising at least one of order data for an order and an order identifier for the order;
the product identifier determination device configured to automatically determine export product identifiers for at least one of products and services identified in the order;
the export license device configured to automatically identify export licenses required for exporting at least one of products and services identified in the order;
the exportable location determination device configured to automatically determine a location of each and every receiver that receives at least one of products and services identified in the order for exporting of the at least one of products and services identified in the order to account for an entirety of a supply chain for the order;
the contract partner assessment device configured to automatically determine whether any contract partner is identified in the order and for each identified contract partner and determine whether at least one of permissions and export licenses are available via the contract partner;
the permissions device configured to automatically assign at least one of permissions and export licenses to at least a portion of the order;
the computer device configured to automatically determine whether any receiver is associated with an embargo state to block at least a first portion of the order to which at least one of product and services are deliverable to a receiver when that receiver is associated with the embargo state to remove that portion of the order and to not block a receiver when that receiver is not associated with an embargo state;
the computer device configured to permit the order when all necessary permissions and necessary export licenses are assigned to the order; and
the computer device configured to automatically block a second portion of the order when all necessary permissions and necessary export licenses are not assigned to the second portion of the order such that the second portion of the order that does not have all necessary permissions and necessary export licenses is deleted or voided and communicating information identifying all necessary permissions and necessary export licenses needed for the blocked second portion of the order via at least one of a display device and a printer, the communicated information being based on a root cause analysis of the order performed by the computer device.

33. The system of claim 32 wherein the product identifier determination device is connected to the permissions device, the export license device is connected to the permissions device, the exportable location determination device is connected to the permissions device, and the contract partner assessment device is connected to the permissions device.

34. The system of claim 32 wherein the computer device is connected to the product identifier determination device via a network connection, the computer device is connected to the export license device via a network connection, the computer device is connected to the exportable location determination device via a network connection, the permissions device is connected to the computer device via a network connection, and the computer device is connected to the contract partner assessment device via a network connection.

35. The system of claim 32 wherein the product identifier determination device, the export license device, the exportable location determination device, the permissions device, and the subcontractor assessment device are interconnected modules and wherein the communicating of the information occurs by the computer device causing the information to be displayed on the display device for a user of the computer device.

36. The system of claim 32 further comprising an advanced warning verification device connected to at least one of the computer device and the product identifier determination device; and
the second portion of the order is a subpart of the order and is not the whole order; and
the blocking voids the second portion of the order and the blocking performed by the computer device also comprises removing items from the order associated with the blocked second portion of the order so that the order is modified to have all necessary permissions and necessary export licenses.

37. An apparatus to provide export control comprising:
a first computer device and a second computer device connected to the first computer device, the first computer device having a processor connected to non-transitory memory, the second computer device having a processor connected to non-transitory memory;
the first computer device configured to determine export product identifiers for at least one of products and services identified in an order and determine whether the order impermissibly includes at least one embargo related entity based on all receivers of the products and services of the order, the receivers comprising at least one intermediate receiver and at least one final receiver;
the second computer device having a plurality of tables stored in the memory of the second computer device; the second computer device configured to determine a location of each and every receiver that receives at least one of products and services identified in the order to account for an entirety of a supply chain for exporting of the products and services identified in the order, the second computer device configured to identify export licenses required for exporting the products and services identified in the order and automatically assign at least one of permissions and export licenses to at least a portion of the order; and
the second computer device configured to block a first portion of the order upon a determination that all necessary permissions and necessary export licenses are not assigned to the first portion of the order such that the first portion of the order is voided or deleted and the apparatus being configured to communicate information via at least one of a printer and a display device connected to the apparatus, the communicated information identifying all necessary permissions and necessary export licenses needed for the blocked first portion of the order based on results of a root cause analysis of the order performed by the apparatus; and
the second computer device configured to not block the order when all necessary permissions and necessary export licenses are assigned to the order.

38. The apparatus of claim 37 wherein the second computer device has an assessor that determines whether any contract partner is identified in the order and for each identified contract partner, determines whether at least one of permissions and export licenses are available via the contract partner.

39. The apparatus of claim 38 wherein the first portion of the order is a subpart of an invoice and is not a whole invoice; and
wherein the blocking voids the subpart of the invoice and the blocking performed by the assessor results in removal of items from the order associated with the blocked subpart to which no necessary permissions and export licenses are available so that the order is modified to have all necessary permissions and necessary export licenses; and
the tables are comprised of a country list table, an embargo list table, a table of available licenses, and a table of available licenses via at least one contract partner.

40. The apparatus of claim 38 wherein the assessor communicates that the first portion of the order that does not have all the necessary permissions and necessary export licenses should be blocked to a user of the apparatus.
